(19) United States
(12) Patent Application Publication
(10) Pub. No.: US 2016/0136654 A1
(43) Pub. Date: May 19, 2016

(54) DRY-PROCESS COAL SEPARATOR

(71) Applicant: Zhihui Yang, Tangshan (CN)

(72) Inventor: Zhihui Yang, Tangshan (CN)

(21) Appl. No.: 14/925,973

(22) Filed: Oct. 28, 2015

(30) Foreign Application Priority Data
Oct. 29, 2014 (CN) 201420637956.8

(51) Int. Cl. B03B 9/00; B07B 13/07; B07B 4/08

(52) U.S. Cl. CPC B03B 9/005; B07B 4/08; B07B 13/07

(57) ABSTRACT

The invention discloses a dry-process coal separator that comprises machine frame with coal supply device, coal preparation device and wind supply device fixed on it. Wherein, coal preparation device comprises separation bed, gangue convey device and vibration motor. The separation bed elastically suspended on the rack, which comprises bed frame and ladder bed surface. The ladder bed surface comprises over 2 subsidiary bed surface of different diameters with gangue discharge and exhaust plenum. The innovation benefits in: the dry-process coal separator effectively realizes the separation of all granularity for raw coal from 0 to 80 mm by setting ladder bed surfaces with its subsidiary bed surface of different diameters inside the bed frame. The operation is easy and economical. The innovation widely applies in discharging gangue and sulfur for raw coal to reduce ash and improve coal's quality, especially for water shortage areas.

### TECHNICAL FIELD

This innovation involves in coal separator technology field and it involves a type of dry-process coal separator specifically.

### BACKGROUND OF THE INVENTION

Dry-process coal separator effectively working for over 13 mm but not for below 13 mm exists on current market. Therefore we cannot do whole grain size separation for raw coal between 0 to 80 mm.

### BRIEF SUMMARY OF THE INVENTION

In order to solve the technology shortage that the coal preparation machine in current technology cannot do whole grain size separation for raw coal between 0 to 80 mm, this innovation design a dry-process coal separator which can realize whole grain size separation for raw coal between 0 to 80 mm, meanwhile the machine has a not complicated structure and a low cost.

In order to achieve the proposes above, this innovation employs following technology projects:

A type of dry-process coal separator consists of rack and coal supply device, coal preparation device, air supply device installed with on the rack. Wherein, the coal supply device is made up of stock bin and coal feeder fixed on the bottom of stock bin; coal preparation device comprises separation bed, gangue convey device installed with on the bottom of separation bed and vibrating motor fixed on both sides of the separation bed. Separation bed elastically suspended on the rack; air supply device comprises the 1^{st} draught fan and L-type blast pipe connected with the air outlet of the 1^{st} draught fan; separation bed comprises bed frame and ladder bed surface installed with inside the bed frame, ladder bed surface consists at least 2 subsidiary bed surface with different aperture; the front end of each subsidiary bed surface is equipped with gangue discharge trough and the bottom end is installed with a wind chamber; in addition, the bottom of wind chamber is flexibly connected with blast pipe. This dry-process coal separator effectively realizes the separation of all granularity for raw coal from 0 to 80 mm by setting ladder bed surfaces inside the bed frame, the apertures of subsidiary bed surfaces that forms ladder bed surfaces are also different.

Furthermore, the inner side of the bed frame roof is installed with adjusting plate, and the adjusting plate is slip connected to the inner side of the bed frame roof, which can adjust the depth of coal rake seam and do some coal segregation in case that the coal is on the center of the bed frame but not on both sides.

Furthermore, a discharge hole is disposing on the tail end of bed frame it can be used to let out some standardized clean coal.

Furthermore, the upward side of each gangue discharge trough is equipped with dam board slip connected with bed frame. This design can adjust the depth of gangue.

Furthermore, gangue convey device consists of capstan, driven wheel and band carrier tensioning in the capstan and driven wheel. The convey mode for gangue is tape transport, due to the fact that the driving belts tightly interwine the capstan and driven wheel and it generates normal pressure from the contact surface between band carrier and capstan, driven wheel. When driving torque makes the capstan rotate, friction drives band carrier, then band carrier makes the driven wheel rotate with overcoming resistance. The conclusion is not complicated and the cost is cheap. It is suitable for some occasion that the centers of two axles are far away.

Preferably ladder bed surface comprises three subsidiary bed surfaces with different aperture. Setting subsidiary bed surface into three parts can basically achieve the purpose of detailed classification. If increasing the amount of subsidiary bed surface, we can improve the effect of segregation. However, the cost may increase at the same time. When the subsidiary is divided into two parts, the segregation result is not ideal.

Preferably this dry-process coal separator also comprises suction hood fixed above the separation bed, the top of the suction hood is equipped with the 1^{st} ventilating opening and the 2^{nd} ventilating opening. The 1^{st} ventilating opening and the 2^{nd} ventilating opening are respectively installed with cyclone dust remover and bag-type dust remover. In addition, cyclone dust remover is connected with the air intake of the 1^{st} draught fan. Adding suction hood and dust remover can effectively achieve the dust extraction during the working process and realize the effect of air recirculation overall.

Preferably this dry-process coal separator also comprises the 2^{nd} draught fan connected with bag-type dust remover. The 2^{nd} draught fan is used for extracting the smoke dust from the suction hood.

This innovation has some beneficial effects: this dry-process coal separator effectively realizes the separation of all granularity for raw coal from 0 to 80 mm by setting ladder bed surfaces inside the bed frame. The operation is not complicated and economical. The innovation can be widely used in all kinds of waste gangue and sulfur discharge of raw coal in order to reduce ash and improve the quality of coal by the separation of all granularity for raw coal from 0 to 80 mm. This dry-process coal separator is specialized in some water shortage areas.

### BRIEF DESCRIPTION OF THE DRAWINGS

FIG. 1 is the sketch for this innovation dry-process coal separator.

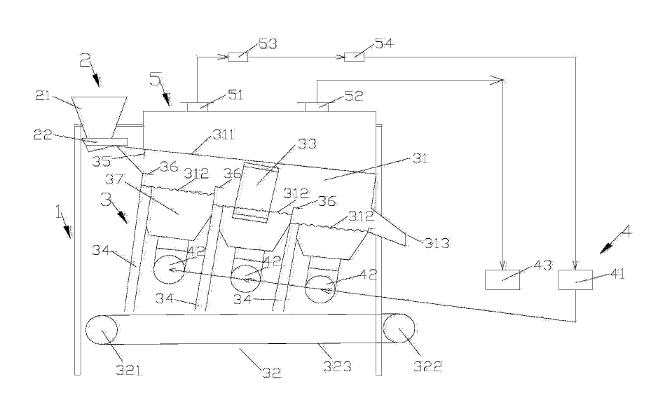

As shown in FIG. 1

As shown in FIGURE a dry-process coal separator comprises a rack 1, a coal supply device 2, a stock bin 21, a coal supply machine 22, a coal preparation device 3, a separation bed 31, a bed frame 311, a subsidiary bed surface 312, a discharge hole 313, a gangue convey device 32, a capstan 321, a driven wheel 322, a band carrier 323, a vibration motor 33, a gangue discharge trough 34, an adjusting plate 35, a dam board 36, a wind chamber 37, an air supply device 4, an 1st draught fan 41, a L type blast pipe 42, a 2nd draught fan 43, a suction fan 5, a 1st ventilating opening 51, a 2nd ventilating opening 52, a cyclone dust remover 53, a bag type dust remover 54.

### DETAILED DESCRIPTION OF THE PREFERRED EMBODIMENT

Next we make a specific explanation about the structure of this innovation based on the attached FIGURE.

As FIG. 1 presents, this innovation provides a dry method coal supply device 2, coal preparation device 3 and air supply device 4; wherein, coal supply device comprises stock bin 21 and coal supply device 22 fixed on the bottom of stock bin; coal preparation device consists of separation bed 31, gangue convey device 32 fixed on the bottom of separation bed and vibration motor 33 installed on both sides of separation bed, separation bed elastically hangs on the rack; air supply device comprises first draught fan 41 and L-type blast pipe 42 connected with the air outlet of the first draught fan. Separation bed consists of bed frame 311 and multistep bed frame, multistep bed frame comprises more than two subsidiary bed frame 312 with different apertures; the front end of each subsidiary bed frame is equipped with gangue discharge trough 34, the bottom end is equipped with wind chamber 37; moreover, the bottom of wind chamber is flexibly connected with L-type blast pipe. This dry-process coal separator has some beneficial effects: this dry-process coal separator effectively realizes the separation of all granularity for raw coal from 0 to 80 mm by setting stepped bed surfaces inside the bed frame. The operation is easy and economical.

This innovation supplies a dry-process coal separator. The inner side of the bed roof is installed with adjusting plate 35, and the adjusting plate is slip connected with the inner side of the bed roof. This design can adjust the depth of coal rake seam and do coal segregation in case that coal is on the center but not on both sides.

This innovation supplies a dry-process coal separator. The tail end of bed frame is equipped with discharge hole 313. The discharge hole is used to ultimately obtain the qualified clean coal.

This innovation supplies a dry-process coal separator. The upward side of all the gangue discharge troughs are equally equipped with dam board 36 and the dam board is slip connected with bed frame. This design can adjust the depth of gangue.

This innovation supplies a dry-process coal separator. Gangue convey device comprises capstan 321, driven wheel 322 and band carrier 323 tensioning on the capstan and driven wheel. The convey of gangue is driven by band, due to the fact that the driving belts tightly interwine the capstan and driven wheel and it generates normal pressure from the contact surface between band carrier and capstan, driven wheel. When driving torque makes the capstan rotate, friction drives band carrier, then band carrier makes the driven wheel rotate with overcoming resistance. The conclusion is not complicated and the cost is cheap. It is suitable for some occasions that the centers of two axles are far away.

This innovation supplies a dry-process coal separator. Stepped bed surface comprises three subsidiary bed surfaces with different apertures. Setting subsidiary bed surface into three parts can basically achieve the purpose of detailed classification. If we increase the amount of subsidiary bed surface, we can improve the effect of segregation. However, the cost may increase at the same time. When the subsidiary is divided into two parts, the segregation result is not ideal.

This innovation supplies a dry-process coal separator. this dry-process coal separator also comprises suction hood 5 fixed above the separation bed, the top of the suction hood is equipped with the first ventilating opening 51 and the second ventilating opening 52. The first ventilating opening and the second ventilating opening are respectively installed with cyclone dust remover 53 and bag-type dust remover 54. In addition, cyclone dust remover is connected with the air intake of the first draught fan. Adding suction hood and dust remover can effectively achieve the dust extraction during the working process and realize the effect of air recirculation overall.

This innovation supplies a dry-process coal separator. This dry-process coal separator also comprises the second draught fan 43 connected with bag-type dust remover. The second draught fan is used for extracting the smoke dust from the suction hood.

When using this machine specifically, we put raw coal needs segregating and some other raw materials into the stock bin, then it provides separation bed with measured raw coal through coal supply machine. The raw coal turns out to be qualified clean coal and outputs from discharge hole after the first, second and third subsidiary bed surface segregations. Gangue conveys from gangue discharge trough to bend carrier and arrive at the designated spot by bend carrier.

The descriptions above are merely some preferable examples of the innovation and they are not restricted to this innovation. Any modifications, equivalent replacements and simple improvements about this innovation are equally comprised within this innovation's protection.

1. A dry-process coal separator, including rack (1), coal supply device (2) installed on the rack, coal preparation device (3) and wind supply device (4), wherein the coal supply device comprises stock bin (21) and coal supply machine(22) fixed on the bottom of stock bin; coal preparation device comprises separation bed(31), gangue convey device (32) installed on the bottom of separation and vibration motor (33) fixed on both sides of separation bed, separation bed is elastically suspended on the rack; wind supply device comprises the first drought fan (41) and L type drought fan (42) connected with the air outlet of the first drought fan; the characteristics lies in that separation bed comprises bed frame (311) and ladder bed surface installed in the bed frame, ladder bed surface comprises more than two subsidiary bed surfaces (312) of different apertures; the front ends of each subsidiary bed surface are equipped with gangue discharge trough (34), the wind chamber (37) is disposing on the bottom ends; and the bottom ends are all slip connected with L type blast pipe.

2. A dry-process coal separator according to claim 1, wherein adjustment plate(35) is disposing on the roof's inner side of bed frame, and the adjustment plate is slip connected to the roof's inner side of bed frame.

3. A dry-process coal separator according to claim 1, wherein a discharge hole (313) is disposing on the tail end of bed frame.

4. A dry-process coal separator according to claim 1, wherein dam-boards (36) is disposing on the upward side of gangue discharge troughs, and dam-boards are slip connected to bed frame.

5. A dry-process coal separator according to claim 1, wherein gangue survey device comprises capstan (321), driven wheel (322) and conveyor belt (323) tensioned between capstan and driven wheel.

6. A dry-process coal separator according to claim 1, wherein ladder bed surface comprises three subsidiary bed surfaces of different aperture.

7. A dry-process coal separator according to claim 1, wherein it comprises suction hood (5) fixed above the separation bed, the top end of suction hood is equipped with the 1st ventilation opening (51) and the 2nd ventilation opening (52), the 1st ventilation opening and the 2nd ventilation opening are respectively installed with cyclone dust remover (53) and bag-type dust remover (54), cyclone dust remover is connected with air intake of the 1st draught fan as well.

8. A dry-process coal separator according to claim 7, wherein it comprises the 2nd draught fan (43) connected on the bag-type dust remover.
